(19) United States
(12) Patent Application Publication
(10) Pub. No.: US 2009/0234187 A1
(43) Pub. Date: Sep. 17, 2009

(54) METHOD OF MICROSCOPIC OBSERVATION OF AN INSIDE OF A BODY OF A SMALL ANIMAL

(75) Inventors: Kaori Higuchi, Tokyo (JP); Chino Sasaoka, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: Olympus Corporation, Tokyo (JP)

(21) Appl. No.: 12/441,009

(22) PCT Filed: Sep. 28, 2007
(86) PCT No.: PCT/JP2007/068978

§ 371 Date: Mar. 12, 2009

(30) Foreign Application Priority Data
Oct. 13, 2006 (JP) 2007-279849

(51) Int. Cl. A61D 99/00

(52) U.S. Cl. 600/114; 128/898

(57) ABSTRACT

In an in vivo microscopic observation method of the inside of the body of an experimental small animal using a stick type objective for an optical microscope, the determination of an observation site in the inside of the body of the animal and the checking of the position of the field of view of the objective can be done without significant increase of the burden of the tested animal. In the inventive method of the microscopic observation of a tissue or a cell in the inside of the body of a small animal, an endoscope is inserted through a first small hole opened in the epidermis site of the small animal; a second small hole piercing through the epidermis of the small animal is opened based on an image of the endoscope; and a thin diameter lens unit of the stick type objective is inserted in the second hole. The position of the tip of the thin diameter lens unit is observed in the image of the endoscope inserted through the first small hole, and thus the field of view of the thin diameter lens unit can be adjusted to the site to be observed.

### TECHNICAL FIELD

The present invention relates to a method of observing the inside of the body of an experimental small animal, such as a mouse, a rat, a guinea pig, a rabbit, etc., and more specifically to a method of carrying out an in vivo observation of a tissue or a cell in the inside of a body of a small animal using an optical microscope.

### BACKGROUND ART

In the fields of medical, pharmacological or biological researches, it may be desired for purposes of various researches to observe a condition of an organ or a tissue in a body of an experimental small animal (tested animal) in vivo and also at a cellular level or at a molecular level (microscopic observation). In that case, there is performed a treatment of opening, from the surface to the body cavity of a tested animal, a hole whose size is enough for the insertion of an objective of an optical microscope (usually 2 to 3 cm in diameter) and for looking for a site to be targeted. However, this treatment burdens a tested animal, rendering a long time observation difficult, and also, there is a risk that the phenomena and conditions in tissues and cells to be observed would be damaged through the opening treatment. Then, in order to enable a microscopic observation of a region, such as the inside of the body of an experimental small animal, not easily accessible to an objective for a conventional optical microscope, Applicant of the present application has developed the “Stick type objective”, designed by (optically) connecting, at the tip of a usual objective, a thin diameter lens unit: a lens unit having a much thinner diameter (up to about 1 mm-5 mm in diameter) than that of a usual objective (For example, see patent documents 1 and 2).

According to such a stick type objective, the tip of the objective is less than 5 mm, and thus, even in a case that the tip of the objective is inserted into the inside of the body or the body cavity of a tested animal for an in vivo microscopic observation of a tissue therein, the hole size on the surface of the tested animal in the opening processing may be at about several mm, so that the burden to the animal is advantageously reduced largely in comparison with the prior art. Further, the optical system in the stick type objective is adapted to be fit to an optical system and a detection system of a usual optical microscope or a laser scanning type optical microscope, and therefore, it is also possible to attach a stick type objective in an existing optical microscope and to use it as it is. In the patent document 1 by Applicant of the present application, there is also proposed a device for fixing the relation between the position of such a stick type objective and an object to be observed in observing the inside of the body cavity of a tested animal with the stick type objective (a device for objective insertion).

Patent document 1: Japanese patent laid-open publication No. 2005-121947
Patent document 2: Japanese patent laid-open publication No. 2006-145771

### DISCLOSURE OF THE INVENTION

### Objects to be Solved with the Invention

In a stick type objective having a thin diameter lens unit as described above, the lens group from a thin diameter lens unit to the main body of the objective is accommodated within a frame made of metal, etc. similarly to objectives for usual optical microscopes, and the whole structure of the stick type objective is rigid because the lens group is necessary to be firmly held in order to attain a high magnification and a high resolution required for the objective. Thus, once a thin diameter lens unit, i.e., the tip of a stick type objective, is inserted into an opened hole having been pierced into the inside of the body or the body cavity of an experimental small animal, it is difficult in that condition to move the thin diameter lens unit perpendicularly to the direction of an optical axis of the lens within the inside of the body or the body cavity. For instance, after the inserting of a thin diameter lens unit in an opened hole, if the field of view (namely, the position) of the (rigid) thin diameter lens unit is forcedly moved for searching a suitable observation site, the opened hole site of a tested animal would be expanded, or the rigid lens unit would damage the inside of the body of the tested animal unnecessarily. Thus, for an in vivo observation of a specific site with a stick type objective, it is necessary to perform the opening treatment after defining an observation site in the inside of the body of a tested animal as accurately as possible. However, since an observation site is in the inside of the body or the body cavity of a tested animal, it is not easy to define such a site from the outside of the animal.

Moreover, even in a case that a thin diameter lens unit has been inserted into a tested animal after defining an observation site to a certain extent, it is difficult to specify the position of the tip from the outside of the animal because the tip of the lens is located in the interior of the animal, and it is also difficult to identify the position of the site actually observed in the interior of the animal, so that the checking of whether or not the field of view of the lens corresponds to a site desired to observe is difficult. Especially, as already noted, the stick type objective has attained a large magnification and a high resolution, comparable to an objective for a usual optical microscope, by means of the lens of a thin diameter, and thus its field of view, whose size is around several hundred micrometers in diameter, is narrower than usual objectives, and also the moving of the tip position of the lens in the inside of the body or the body cavity of a tested animal is not easy, and consequently, it is difficult to grasp which portion of an organ the present field of view of the thin diameter lens unit is located at in the inside of the body or the body cavity of a tested animal.

Accordingly, if there is a method enabling one to relatively easily and more accurately perform the determination and checking of an observation site in the inside of the body or the body cavity of a tested animal and the checking of the position of the field of view of a stick type objective without significant increase of the burden of the tested animal, an in vivo microscopic observation of a tissue or a cell in the inside of the body or the body cavity of an experimental small animal can be conducted while the advantage that the stick type objective can be relatively easily inserted in the inside of a small animal is utilized more effectively.

### Method for Solving Objects

According to the present invention, there is proposed a novel method enabling, through a combined use of an objective having a thin diameter lens unit for an optical microscope and an endoscope, an in vivo microscopic observation of a tissue and/or a cell of a small animal in a manner that the determination of an observation site and the checking of the position of the field of view of an objective in the inside of the body or the body cavity of the small animal are made without increasing the burden of the small animal significantly.

According to one aspect of the present invention, a method of in vivo microscopic observation of a tissue or a cell in an inside of a body of a small animal with an objective having a thin diameter lens unit comprises the steps of: opening in an epidermis site of the small animal a first small hole which can seal up the inside of the body of the small animal; supplying gas to the inside of the body of the small animal through the first small hole to form a space in the inside of the epidermis site; inserting an endoscope in the inside of the body of the small animal through the first small hole; opening in an epidermis site of the small animal a second small hole which can seal up the inside of the body of the small animal; inserting the thin diameter lens unit of the objective into the second small hole; observing a position of a tip of the thin diameter lens unit inserted in the second small hole with the endoscope inserted through the first small hole, and positioning the tip of the thin diameter lens unit based on an image of the endoscope; and observing a tissue or a cell of the inside of the body of the small animal with the objective having the thin diameter lens unit. In this regard, the reason that the first and second small holes are formed to be capable of sealing up the inside of the body of the tested animal is for preventing the space, formed by the gas having been supplied into the inside of the body of the tested animal for making observation with the endoscope or the objective easy, from being shrunk owing to the flowing out of the gas to the exterior of the body. Further, in a case that the endoscope has a means for sending out gas, the supplying of the gas to the inside of the body of the small animal for providing the space inside the epidermis site may be carried out after the insertion of the endoscope through the first small hole, and it should be understood that such a case is within the scope of the present invention. Furthermore, in order to make the insertion of the endoscope into the first small hole easy, a trokar may be inserted before the inserting of the endoscope into the first small hole.

In accordance with the above-mentioned method of an in vivo microscopic observation of a tissue or a cell of an inside of a body of a small animal, an endoscope is inserted in the inside of the body of a small animal prior to the performing of opening treatment for the insertion of a thin diameter lens unit of an objective, and a space is formed in the interior of the small animal to establish a condition where the inside of the body of the small animal is observable in a large area with the endoscope, and then, the thin diameter lens unit of the objective will be inserted. As well known in the art, the endoscope is a device which has one end of a flexible tube, made of a bendy, light-transmittable material, such as an optical fiber, to be directed to an observation site, and the other end of the tube equipped with a photodetector, enabling the observation of a condition of the observation site by leading luminescence or reflected light from the observation site to the photodetector through the flexible tube. Thus, although an image cannot be acquired at a resolution and/or a magnification of a level comparable to objectives of optical microscopes, the neighborhood of the tip of the flexible tube being directed to the observation site can be bent comparatively freely, and its field of view is larger than the field of view of objectives for optical microscopes. Then, in the present invention, this feature of the endoscope is utilized, as shown in the following embodiments, for observing and grasping a condition in a wide area of the inside of the body or the body cavity of a tested animal in the image within the field of view of the endoscope, and thereby performing the determination or the checking of the position of the tip of the thin diameter lens unit of the objective (whose degree of freedom of movement is small once inserted into the inside of the body of an animal). According to this structure, even when the position of the inserted tip of the thin diameter lens unit cannot be checked from the outside of the tested animal, which site in the inside of the body of the tested animal is being observed in the field of view of the objective can be confirmed easily.

In the above-mentioned method, when it is desired to observe a certain specific site of the inside of the body of a small animal, e.g. a specific site of a certain organ, etc., an observation site in the inside of the body of the small animal may be predetermined with the endoscope and the second small hole may be opened at the position which renders the observation site observable when the thin diameter lens unit is inserted in this second small hole in the step of opening the second small hole which can seal up the inside of the body of a small animal, i.e., the hole for inserting the thin diameter lens unit of the objective. Then, when the tip of the thin diameter lens unit is inserted into the second small hole, the tip of the thin diameter lens unit is positioned at the position rendering the above-mentioned, predetermined observation site observable based on the image of the endoscope. According to this structure, even when an experimenter or an observer is not able to determine or confirm the position of a site to be observed in the inside of the body of the tested animal in eye observation from the outside of the tested animal, he can grasp the condition of the inside of the body of the tested animal with the image of the endoscope, and therefore, a site to be observed is defined or checked before the opening of the second small hole, and the possibility that the opening has been erroneously executed at a position on the epidermis of the tested animal not rendering the site to be observed observable is reduced.

Further, according to the above-mentioned method, because the position of the observation site can be checked with the endoscope, it becomes possible to extract the thin diameter lens unit from the second small hole; to insert into the second small hole a second objective having a thin diameter lens unit whose magnification or numerical aperture differs from those of the objective having been used so far; and then, to observe, with the endoscope which remains inserted in the first small hole, the tip position of the thin diameter lens unit of the second objective inserted in the second small hole and the site having been observed so far (the site which had been observed with the extracted objective); to position, based on the image of an endoscope, the tip of the thin diameter lens unit of the second objective unit at the position such that the site which was observed with the extracted former objective becomes observable; and to observe the observation site with the second objective having the thin diameter lens unit. According to this procedure, advantageously, the same observation site can be observed in various different magnifications or resolutions.

By the way, in a case that an endoscope is used for determining an observation site to be observed with a stick type objective, if a certain mark is put on the observation site which has been observed in the image of the endoscope such that the position of the site can be checked by an experimenter or an observer from the outside of a tested animal, then the endoscope no longer needs to be used. Thus, according to another aspect of the present invention, in a method of an in vivo microscopic observation of a tissue or a cell in an inside of a body of a small animal with an objective having a thin diameter lens unit, there are performed, similarly to the above-mentioned aspect, the steps of: opening in an epidermis site of the small animal a first small hole which can seal up an inside of the body of the small animal; supplying gas to the inside of the body of the small animal through the first small hole to form a space in the inside of the epidermis site; and inserting an endoscope in the inside of the body of the small animal through the first small hole (When the endoscope has a means for supplying gas, the gas may be supplied to the inside of the body of the small animal through the endoscope so as to form a space in the inside of the epidermis site after the insertion of the endoscope in the first small hole); and after these, there are performed the steps of: determining an observation site of the inside of the body of the small animal based on the image of the endoscope and providing a marker to a portion of the inside of the body of the small animal so that the position of the determined observation site can be identified by eye observation from the outside of the small animals; opening a second small hole in an epidermis site of the small animal adjacent the observation site defined with the marker; and inserting the thin diameter lens unit in the second small hole, and thereby, the observation site defined or specified with the marker can be observed with the objective. In this regard, as in the above-mentioned aspect, in order to make the endoscope easily inserted into the first small hole, a trokar may be inserted into the first small hole prior to the insertion of the endoscope.

In this aspect, as described above, a marker is provided to a site to be observed or a site which enables one to specify a site to be observed in the inside of the body of a tested animal, and thereby, the site to be observed can be checked from the outside of the tested animal at the opening of the second small hole on the tested animal, so that the possibility that a hole would be opened at an erroneous position, i.e., a position which does not enable one to observe the site to be observed can be reduced. In this respect, in the above, “a marker” may be an arbitrary mark, e.g. provided through the coloring of an observation site or its neighborhood, which enables an experimenter or an observer to identify its position by his eyes from the outside of a tested animal. For example, a marker may be a viscous, colored liquid material. In that case, the endoscope may have a means for sending out a marker, which (viscous liquid material) will be sent out from the endoscope so as to be given to, or to adhere on, the observation site. Further, when illumination light emitted from the tip of the inserted portion of the endoscope can be seen from the outside of a tested animal, coloring or other marks may be provided onto an epidermis adjacent the observation site from the outside of the tested animal based on the position of the illumination light.

In the above-mentioned manner, it should be understood that, since the position at which the second small hole should be opened can be determined with a marker, the endoscope may be extracted from the first small hole after the marker is provided. In a case that the observation of the inside of the body of the animal with the endoscope is not continued, the space formed in the inside of the body of the animal is no longer necessary, and therefore the second small hole may not be a hole which can seal up the inside of the body of the animal. When the space is reduced, the observation site will become close to the epidermis, so that the position of the marker can be easily checked from the outside of the tested animal, and also, the insertion length of the thin diameter lens unit of the objective can be reduced, which may be more advantageous, depending on an observation purpose of an experiment.

A site of the inside of the body of a small animal which can be observed by the above-mentioned present invention is typically in the inside of the body cavity of an animal, but such a site may be in the other portions, for example, the head, the neck, the leg, the tail, etc. of an animal, and it should be understood that such cases also fall into the scope of the present invention.

### EFFECT OF INVENTION

In general, it can be said that, by the simultaneous use of an optical microscope with a stick type objective and an endoscope, the present invention enables an in vivo observation of the inside of the body or the body cavity of a small animal (especially, an experimental small animal) at a cellular or a molecular level, namely at a high magnification and a high resolution, and under the condition where the observed site is more surely determined or confirmed without an extensive increase of the burden of a tested animal. In the prior art, the position of the tip of a stick type objective, i.e., its field of view, can hardly be shifted after it has been inserted in a tested animal (After the insertion, the wide area scan of the sample for looking for an observation site and/or for checking the position of the present field of view is not executable), and thus, it has been difficult to check, from the outside of the tested animal, where the position of the field of view is in the inside of the body of the tested animal: however, according to the present invention, by the use of the image of an endoscope, the position of the observation site of a stick type objective can more certainly be determined, and/or the field of view of a stick type objective can be adjusted more accurately to a site desired to observe. Accordingly, after inserting a stick type objective in a tested animal, the position of the stick type objective hardly needs to be moved, and also, it can be avoided that an experiment would be made in vain owing to that the position of the field of view of a stick type objective, i.e., the observation site, cannot be determined.

Moreover, when a site desired to observe is predetermined with the image of an endoscope, the position through which a stick type objective should be inserted can be determined with more sufficient accuracy, and therefore, it becomes possible to perform an opening treatment on the epidermis at the most suitable site for observing a site to be observed in a tested animal, and also, it is expected that the tip position of a stick type objective, after being inserted into the opened hole, hardly needs to be moved (except in the direction of an optical axis of the lens). Consequently, the hole size of the opening for the stick type objective may be substantially at a size of the diameter of the thin diameter lens unit of the stick type objective, and thus, it is not necessary to open a big hole in a tested animal so that the burden of the tested animal can be largely reduced (The size of the hole into which an endoscope is inserted may also be at a size enabling the insertion of the inserted portion made of the flexible tube of an endoscope, and therefore, the burden of a tested animal will not increase largely). Further, since the position of the hole into which a stick type objective is to be inserted can be determined more correctly with an endoscope, the trial and error in the opening of the epidermis of a tested animal (operation of reopening a hole in a different site, or expanding a hole) will be reduced, and thereby, the burden of a tested animal is further largely reduced.

The other objects and advantages of the present invention will be clarified in the explanation of the following preferable embodiments of the present invention.

### BRIEF EXPLANATION OF THE DRAWINGS

FIG. 1 (A) is a schematic diagram of a microscopic observation system used for performing an embodiment of the present invention. For the simplicity of the drawing, accessories etc. are omitted. FIG. 1 (B) is a schematic diagram of a stick type objective.

FIG. 2 (A) is a schematic diagram of a system of an endoscope used for performing an embodiment of the present invention. For the simplicity of the drawing, accessories etc. are omitted. FIG. 2 (B) is a typical front view of the tip of the inserted tube portion of an endoscope.

FIG. 3 is schematic diagrams explaining conditions in an embodiment of the present invention. (A) shows a condition where a tested animal is secured; (B), a condition where a catheter is inserted into the tested animal; (C), a condition where a rubber cap for inserting an endoscope is attached with the catheter; and (D), a condition where an endoscope is inserted in the interior of the tested animal. (B)-(D) each show only the portion in which any changes occur through the operations.

FIGS. 4 (A) and (B) are schematic diagrams of a SURFLO cannula for equipping a tested animal with a catheter. (A) shows a condition where the catheter is removed from the SURFLO cannula; and (B) shows a condition where the catheter has been inserted in the SURFLO cannula. The catheter is inserted in a tested animal in the condition of (B), and then, only the SURFLO cannula is drawn out. In this regard, the tip of the catheter may be cut aslant for making its insertion easy.

FIG. 5 is schematic diagrams explaining the steps of forming a second small hole pierced from an epidermis of a tested animal to its body cavity. The second small hole is formed by the perforation from a muscular tunic with a needle etc. In this regard, for the purpose of the explanation, the size of the small hole is exaggeratedly shown in the diagram.

FIG. 6 is a schematic diagram explaining a condition in an body cavity, where a thin diameter lens unit has been inserted into the body cavity of a tested animal through the second small hole.

FIG. 7 (A) is a schematic diagram of a guide tube used with a stick type objective; and FIG. 7 (B) is a typical, enlarged sectional view of the tip portion of a guide tube. In the drawing, a guide holding portion is fixed to a support base 14 of a microscopic observation system.

FIG. 8 shows a bright field image and a fluorescence image (and a schematic diagram for explanation) of an endoscope inserted into the body cavity of a mouse. In the experiment, the venous blood vessel is bright according to the fluorescence of AngioSense (fluorescence image). The tip of a thin diameter lens unit is positioned near the venous blood vessel of a stomach outer wall.

### BEST MODE FOR PERFORMING THE INVENTION

Referring to the accompanying drawings, the present invention will be explained in detail with respect to some preferable embodiments in the followings. The same reference numeral indicates the same portion in the drawings.

The Scheme of an In Vivo Microscopic Observation System

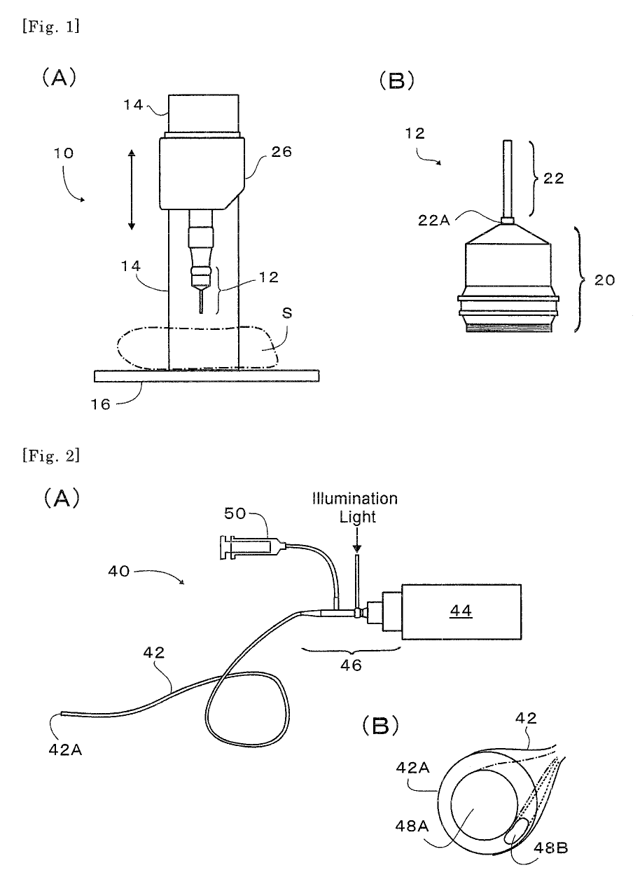

A preferable embodiment of the inventive method of an in vivo microscopic observation of a tissue and/or a cell in the inside of the body of a small animal is preferably performed by means of an in vivo microscopic observation system (Olympus IV100) as shown in FIG. 1. Referring to the drawing, in general, the microscopic observation system 10 comprises a stick type objective 12, a support base 14 which supports the former, and a pedestal 16 on which a small animals S, used as a tested animal, is laid. The stick type objective 12, as shown more enlargedly in FIG. 1 (B), comprises a main body portion 20 having an appearance almost similar to a usual objective and a thin diameter lens unit 22 connected at the tip of the main body portion. In the interior from the tip of the thin diameter lens unit 22 to the main body portion 20, a plurality of lenses (not shown) are adjusted and arranged so that a magnification and a numerical aperture equivalent to those of usual objectives for optical microscopes may be attained, and therefore, the frame of the stick type objective 12, including the thin diameter lens unit; 22 and its connection 22A, is made rigid with metallic material, such as stainless steel, similarly to usual objectives, for optical microscopes. Further, although the stick type objective 12 may be attached in an usual erecting type optical microscope, in this embodiment, it is adapted to be removably attached to a scanning unit 26 equipped on the support base 14. In the inside of the scanning unit 26, an optical system of a laser scanning type fluorescence microscope is constructed, in which there are provided a galvanomirror for leading light received from not illustrated light sources, such as a laser, to the end of the thin diameter lens unit 22, and scanning the inside of the field of view of the thin diameter lens unit 22 with the light for illumination; and a dichroic mirror, a filter, etc. which lead the fluorescence from the sample to a photodetector (not shown). The stick type objective 12 and the scanning unit 26 can be moved up and down on the support base 14 as one unit, and thus, it is possible to insert the thin diameter lens unit 22 in the interior of the tested animal S at a desired depth. For the stick type objective, preferably, objectives of various magnification and numerical apertures are prepared so that one can use a stick type objective while resetting it on a scanning unit 26 appropriately in accordance with an observation purpose.

Furthermore, in the present invention, together with the above-mentioned microscopic observation system, an endoscope 40 as schematically illustrated in FIG. 2 (A) is used for observing a broader area of the inside of the body of the tested animal, and for checking the position of the tip of the thin diameter lens unit 22 inserted in the inside of the body of the tested animal. The endoscope 40 has a flexible inserted tube portion 42 (Pf8P for pancreatic and bile ducts) having a diameter of a little less than 1 mm (for example, 0.8 mm); and a base 46 including a coupling for transmitting illumination light into the inserted tube portion 42 at its one end and a dichroic mirror for transmitting the light from the other end (tip end 42A) of the inserted tube portion 42 to a photodetector 44 (a CCD camera, etc.). In the inserted tube portion 42 as illustrated in FIG. 2 (B), there may be provided an optical passage (optical fiber) 48A which transmits light between its opposite ends and a fluid passage 48B which sends out gas or liquid from the base 46 to the tip end 42A. In emitting illumination light from the tip end 42A, the light of a laser or a lamp, not shown, is condensed to the coupling in a usual manner. At the tip end 42A, a lens (an objective of the endoscope) may be arbitrarily attached for condensing the emitted light to a certain extent and for obtaining an image of the inside of the body of an animal. Moreover, in flowing fluid into the fluid passage 48B, a syringe 50, etc. in which the fluid to be sent out to the interior has been filled up is connected thereto, and, by pushing a piston of the syringe 50, the fluid is discharged through the passage in the base 46 and the fluid passage 48B in the inserted portion 42 from the outlet of the fluid passage 48B at the tip end 42A. In this regard, the observation of the inside of the body of the animal with the endoscope may be performed in a bright field observation mode or a fluorescence observation mode, and thus, in the base 46, optical systems each for the bright field observation and fluorescence observation (not shown) are constructed and usable by switching them appropriately in between.

Accordingly, in the above-mentioned structure, the inserted tube portion 42 of the endoscope 40 and the thin diameter lens unit 22 of the stick type objective 12 are inserted in the inside of the body of the tested animal S laid on the pedestal 16 of the microscopic observation system 10, and then, while the condition of the larger area of the inside of the body of the tested animal S and the tip of the thin diameter lens unit 22 are checked with the endoscope 40, the detailed observation of an observation site is performed with the stick type objective 12 at a cellular or molecular level.

Observation Method

As noted above, the observation with the stick type objective 12, i.e., the observation with the optical microscope, is performed in the fluorescence observation mode, and the observation with the endoscope 40 is performed in the fluorescence observation mode or bright field observation mode. Accordingly, the method of observation with the stick type objective and observation with the endoscope may be performed in either of the following manners.

(1) An observation site in a tested animal is labeled with a fluorescent reagent, and then, the observation with the optical microscope and the observation with the endoscope are performed in the fluorescence observation with the fluorescent reagent. In this respect, a plurality of kinds of fluorescent reagents may be used. Moreover, in a case that the resolution or intensity of a fluorescence image in the fluorescence observation with the endoscope becomes lower than those in the observation with the optical microscope, different fluorescent reagents may be used between the observation with the optical microscope and the observation with the endoscope in order to increase the sensitivity in the observation with the endoscope (The amount of the labeled reagent used for the observation with the endoscope may be increased).
(2) Using an experimental small animal in which fluorescent proteins (GFP etc.) are genetically expressed or an experimental small animal in which a gene expression is made so as to induce chemoluminescence (luciferin-luciferase, etc.) for a tested animal, the observation with the optical microscope and the observation with the endoscope are performed with fluorescence or luminescence in the animal's tissues. In this regard, one of the observation with the optical microscope and the observation with endoscope may be performed with fluorescence or luminescence obtained through gene expression, and the other may be performed with fluorescence of a labeled fluorescent reagent.
(3) The observation with the optical microscope is performed by the above-mentioned method (1) or (2), and the observation with the endoscope is performed in a bright field observation.

Preparation of a Tested Animal

The small animal observed by the inventive method may be an experimental small mammal, such as a mouse, a rat, a guinea pig, and a rabbit, but it may also be an ave, such as a fowl, a reptile, an amphibian, such as a frog and a newt, or a fish. Typically, an observation site may be at various organs in the body cavity of a tested animal, but, may be other sites in an animal, such as a head, a leg, a tail portion, etc., if an endoscope can be inserted therein. In a case that an observation with an optical microscope or an observation with an endoscope is performed in the fluorescence observation with a fluorescent reagent, at least a region or Et site to be observed in a tested animal is fluorescently labeled with an arbitrary fluorescent reagent. Moreover, especially when an observation with an optical microscope or an observation with an endoscope is performed with fluorescence or luminescence of fluorescent proteins or chemoluminescent proteins, an animal in which such fluorescent proteins or chemoluminescent proteins have been genetically expressed by an arbitrary process is chosen for a tested animal.

As noted, since an observation with an optical microscope is performed in a fluorescence observation, preferably, food for a tested animal is switched from usual food to fluorescence-removed food, for example, two days before the observation for reducing the autofluorescence by food (This is also done in the case of a tested animal in which fluorescent proteins or chemoluminescent proteins have been genetically expressed). After this, in observation with the fluorescence of a fluorescent reagent, the fluorescent reagent is dosed to a tested animal per os or per vein such that a site to be observed is fluorescently labeled with the fluorescent reagent. For fluorescence reagents, for example, fluorescent antibody reagents, such as Prosense or OsteroSense; or blood vessel shadowing agents, such as AngioSense, etc. may be used. The time for the dosage may be appropriately determined, taking into account the reaction time, the metabolic and decomposing time, etc. of a fluorescent reagent in the inside of the body of a tested animal.

The Procedures in Observation

The procedures in the observation in preferable embodiments of the inventive in vivo microscopic observation method are as follows:

### The First Embodiment

In this embodiment, generally, an endoscope is first inserted into the body cavity of a tested animal before the inserting of a stick type objective, and a site to be observed with the stick type objective is determined. After that, under the condition that the endoscope has been inserted, the opening of a hole for inserting the stick type objective in the tested animal is carried out, and then, the tip of the stick type objective is inserted in the hole, and the adjustment and checking of the position of the tip of the stick type objective are performed so that the site determined with the endoscope is made observable. The detailed procedures are as follows:

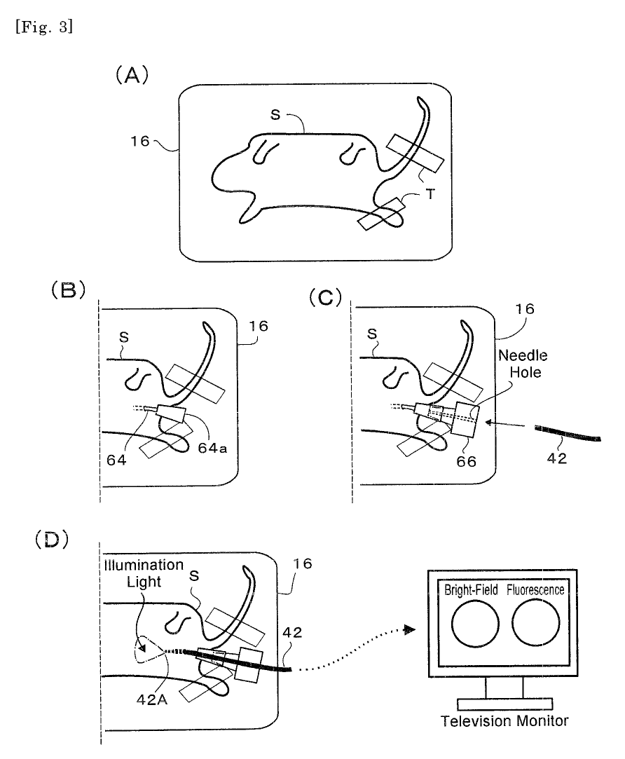

(a) Preparation just before the observation of a tested animal—For a tested animal prepared for performing a fluorescence observation as above, an anesthetization treatment is performed similarly to a case of a usual in vivo observation. The anesthetization of a tested animal may be done by exposure of the tested animal under evaporated isoflurane atmosphere or by intraperitoneal injection of anesthetic drug (pentobarbital, sevoflurane, etc.) at a normal amount. Next, the tested animal S is fixed on the pedestal 16 of the microscopic observation system 10 with tape T, etc., in the position where an organ to be observed is turned up (FIG. 3 (A)). In this respect, in order to prevent the tested animal from awaking during the observation, evaporated isoflurane gas may be supplied to the mouth and nasal region of the tested animal. Further, in using a fluorescent reagent, such as AngioSense, having a short metabolic and decomposing time, the dosage per vein may be appropriately carried out when the tested animal is fixed. Moreover, if required, the epidermis near the observation site may be shaved in order to prevent hair from entering into the observation site.

(b) Insertion of an endoscope—After the fixing of the tested animal S on the pedestal 16, the first small hole is opened so as to pierce a site on the epidermis of the tested animal, rather separated from a site where an organ to be observed is expected to be located. The opening operation of the first small hole may be done by piercing the epidermis of the tested animal with a SURFLO cannula 60 as illustrated in FIG. 4 (TERUMO CORP., needle gage 14G, and around 1-2 inches in length). The SURFLO cannula 60, as illustrated, is an apparatus in which a flexible catheter 64 with a length of about 2-3 cm is put on an inner needle 62 with a rigid, sharp tip (FIG. 4 (B)). In this connection, the catheter 64 may be obtained by cutting a long catheter to be shortened at about 2-3 cm in length. After the SURFLO cannula is inserted so as to pierce through the epidermis of the tested animal into its body cavity, the catheter 64 will be left passing through the epidermis in the tested animal S with a catheter hub 64a by drawing out the inner needle 62 therefrom, and thereby, the catheter 64 will form the first small hole for inserting an endoscope (FIG. 3 (B)). In this regard, since the catheter 64 pierces through the epidermis while tightly contacting the epidermis and muscular tunic of the tested animal, the first small hole formed by the catheter 64 is capable of sealing up the inside of the body cavity of the tested animal from its exterior. Further, on the catheter hub 64a, a rubber cap 66 (PRN Adopter; made by BD corp.) in which a hole has been formed with e.g., a needle 18G etc. is arbitrarily attached for stably supporting the inserted portion of an endoscope, and thus, the catheter 64 functions as a trokar (an overcoat tube) for introducing an endoscope in the first small hole (FIG. 3 (C)).

After the trokar for the insertion of an endoscope is formed as above, a syringe (for example, 5 ml-10 ml in volume) is connected to the rubber cap of the trokar prior to the inserting of an endoscope, and gas is supplied into the body cavity to expand a peritoneum, forming a space in the body cavity. In this regard, at this time, it can be checked from the expansion of the peritoneum with gas that the trokar has penetrated to the body cavity (Because of the flexibility, the catheter 64 is easily sealed by the epidermis and muscular tunics, so that the gas is held in the body cavity). Then, the inserted tube portion 42 of the endoscope 40 is inserted into the trokar (FIGS. 3(C)-(D)). In this connection, in a case that the inserted tube portion of an endoscope has a means to send out fluid as described above, gas may be sent out into the body cavity through the fluid passage of the endoscope after it is inserted in the trokar.

(c) Observation with an endoscope—After the endoscope is inserted in the trokar as described above, the condition in the body cavity is observed with the endoscope (An image of the endoscope is shown on a television monitor, etc. as a screen image from a photodetector, such as a camera, in a usual manner. (FIG. 3 (D)). In observation with the endoscope, one can observe a large area in the body cavity while holding the endoscope by hand and using the first small hole into which the trokar has been inserted as a fulcrum. Further, because the bright field observation and the fluorescence observation are available with the endoscope, the optical system of the endoscope is appropriately changed so that the bright field observation or the fluorescence observation is performable (the simultaneous observation of a bright field image and a fluorescence image is also possible by choosing the wavelength for the bright field appropriately); and thus, an organ to be observed and a site to be observed are searched and determined. In this respect, when the endoscope is inserted into the body cavity of the tested animal and illumination light is applied, an experimenter can check the region currently illuminated from the outside of the tested animal (FIG. 3 (D)). Accordingly, it is possible based upon the distribution of the illumination light and the image of the endoscope to identify where a certain organ or a certain region is located from the outside of the tested animal. Further, the endoscope may be pulled out in order to wash the tip of the inserted section to remove soils each time when the observation is disabled owing to the tip portion of the endoscope becoming dirty.

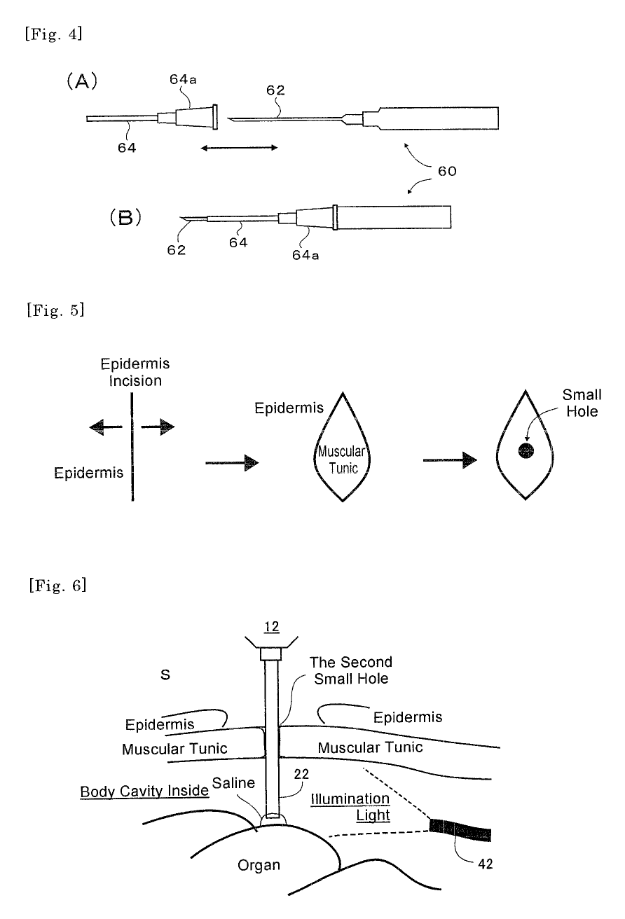

(d) Insertion of a stick type objective—After an organ or an observation site to be observed is determined, a hole passing from an epidermis close to the site into the body cavity is opened to form the second small hole for inserting the thin diameter lens unit of a stick type objective. This second small hole can be formed, for example, by cutting skin (epidermis) of about 1 cm in length above the targeted organ or site with a scalpel or scissors; exposing the muscular tunic; and piercing the peritoneum from the muscular tunic with a needle, etc. (FIG. 5). In this regard, the second hole also seals up the inside of the body cavity from the outside of the animal by contraction of the muscular tunic, and thus the gas in the body cavity is not easily discharged. Then, when the hole passing into the body cavity is formed, the objective 12 on the support base 14 is brought down (FIG. 1 (A)), and the thin diameter lens unit 22 is inserted through the second hole (FIG. 6).

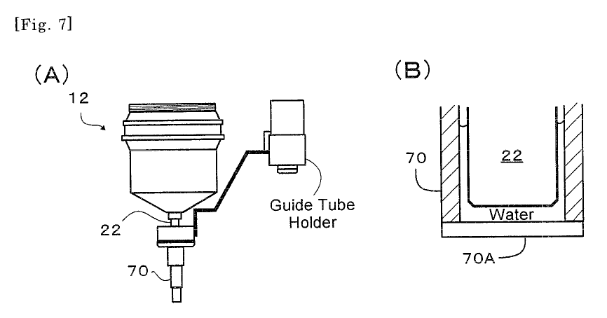

In this connection, at the inserting of the thin diameter lens unit 22 into the second hole, preferably, about 50 μl of physiological salt solution is laid on the dissected region of the epidermis. One of its reasons is because the thin diameter lens unit 22 is designed as a water-immersion type so that the lens's own designed performance can be exerted and a good microscopic image can be obtained when the observation site and the tip of the lens are immersed in water; and another reason is for prevention of the observation site being dried and prevention of necrosis of cells (When pure water is used, cellular necrosis is liable to occur). Further, the thin diameter lens unit 22 may be inserted in the second hole while being covered in a guide tube 70 as shown in FIG. 7 (A). The guide tube 70 is closed at its tip with a transparent member, and so adapted that liquid can be held in its inside (FIG. 7 (B)). Thus, by inserting the thin diameter lens unit 22 into the guide tube 70 filled with an appropriate amount of water therein and holding the distance between the thin diameter lens unit 22 and the bottom 70A of the guide tube at the focal distance of the thin diameter lens unit 22, the focus of the thin diameter lens unit 22 is rendered properly consistent with the guide tube's bottom 70A, and thus, by applying the guide tube's bottom 70A on the observation site, a good microscopic image of the observation site can be obtained.

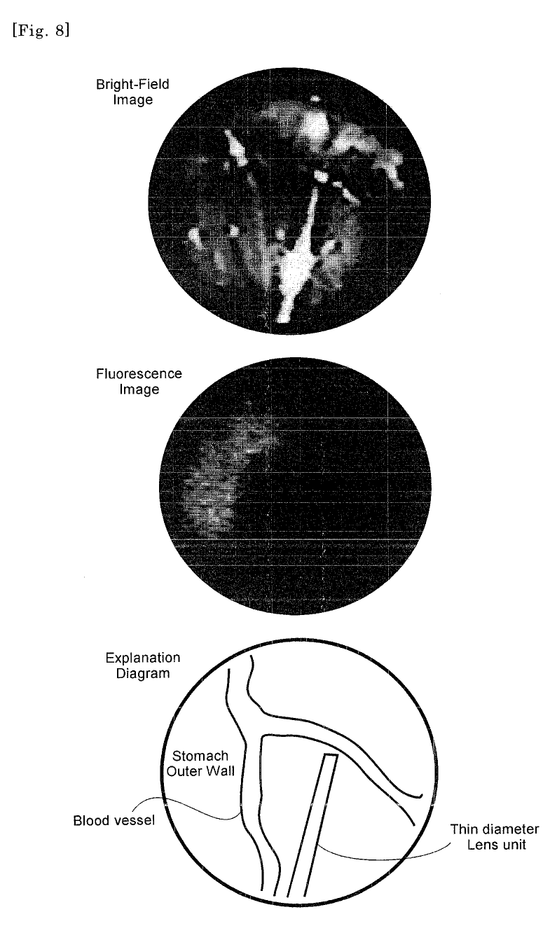

(e) Observation with an optical microscope—When the thin diameter lens unit 22 is inserted in the second small hole, which position in the body cavity of the tested animal the thin diameter lens unit 22 is located on can be checked based upon the image of the endoscope as shown in the endoscope images of FIG. 8. Thus, while checking whether or not the tip of the thin diameter lens unit 22 is directed to the targeted observation site (if the guide tube 70 is used, whether or not the guide tube's bottom is applied on the observation site or not), the focus of the image of the thin diameter lens unit 22 is adjusted so that the in vivo fluorescence observation of the observation site can be achieved with the thin diameter lens unit 22. In this respect, as already noted, in the present embodiment, the microscopic observation system is a system which can be set up as a laser scanning fluorescence microscope, and therefore, in order to obtain a good fluorescence image, a laser wavelength and an optical system, such as mirrors, are appropriately selected in accordance with the characteristics of the observation site. Similarly to a usual fluorescence observation, the wavelength of the laser and the wavelength characteristics of dichroic mirrors and filters will be determined taking into account absorbance and emission wavelength characteristics of a fluorescent dye (or protein) to be used. When the chemoluminescence is detected, no illumination of excitation light is required.

If the tip of the thin diameter lens unit 22 cannot be turned to the targeted observation site, the position of a thin diameter lens unit 22 may be moved in the extent that no organs or tissues in the body cavity of the tested animal are damaged and the second hole is not expanded. Though not illustrated, when the microscopic observation system 10 is equipped with a mechanism enabling the inclining of the stick type objective from the vertical direction, the stick type objective may be inclined around the second small hole as a fulcrum. Further, also in moving the position of the stick type objective, the position of the thin diameter lens unit 22 can be checked with the endoscope, and therefore it should be understood that the moving of the thin diameter lens unit 22 without damaging the inside of the body cavity of the tested animal can be done more easily than the prior art.

Furthermore, if the targeted observation site is unobservable from the second present small hole, the processes of the above-mentioned (c) and (d) may be repeated for opening a new small hole. In this respect, the size of the second small hole may be around a size through which the thin diameter lens unit 22 can pass, and therefore, even if it is necessary to open a new hole, there is no need to open a big hole of several centimeters as in the prior art, so that the burden of a tested animal will be greatly reduced.

(f) Exchange of a stick type objective—In a case that stick type objectives of various magnifications or numerical apertures (resolutions) are prepared, in accordance with the purposes of observations, after drawing out the thin diameter lens unit 22 from the second small hole, a different stick type objective may be attached on the support base 14 (the scanning unit 26), and an observation may be performed through the above-mentioned processes (d) and (e). Since the second small hole has been already formed, the thin diameter lens unit of the different stick type objective is inserted into the second formed small hole. Further, since the site observed so far can be checked easily with the endoscope, it is also easy to mate the position of the tip of the newly inserted thin diameter lens unit with the position observed before.

### The Second Embodiment

In this embodiment, in general, similarly to the first embodiment, first, an endoscope is inserted into the body cavity of a tested animal, and a site to be observed with a stick type objective is determined, and then, by discharging colored liquid material including coloring matter, etc. from a fluid passage of the endoscope, a marker (a mark) which can be viewed by an experimenter from the outside of the tested animal is adhered to the inside of the body of an animal. The marker may be applied to the observation site itself, but it may be applied to a site which enables an experimenter to identify the position of the observation site when he views the marker from the outside of the tested animal. Then, a hole, into which a stick type objective is to be inserted, is opened on an epidermis of the tested animal specified with the marker, and the stick type objective is inserted therein. As for the procedures, from (a) Preparation of a tested animal to (c) Observation with an endoscope may be performed similarly to the first embodiment. The procedures following these will be performed as follows:

(g) Marking of an observation site—After the determination of the observation site with the endoscope, the tip of the inserted portion of the endoscope is moved to the observation site or its perimeter, and colored, viscous liquid material is discharged out through the fluid passage (FIG. 2B) of the inserted portion so as to adhere to the observation site or its perimeter, where this viscous liquid material is made as the marker of the observation site. The colored, viscous liquid material may be, for example, Lowmelt agar or other gel materials containing dyestuffs, such as ink. The viscous liquid material is pushed out from the end (not shown) of the fluid passage in the base 46 of the endoscope by means of the syringe 50, etc. (FIG. 2A). It should be understood that the function of the marker is to enable the identification of the observation site by eye observation from the outside of the tested animal, and therefore, the marker may be adhered to a perimeter of or near the observation site, not on the observation site. In this connection, alternatively, if the illumination light emitted from the tip of an endoscope can be viewed by eye observation from the outside of a tested animal during an observation with the endoscope, a marker may be applied with ink, etc. on the epidermis close to a site to be observed with an optical microscope based upon the distribution of the illumination light observed from the outside of the tested animal. Then, when the marker is applied, the endoscope is drawn from the tested animal.

(h) Insertion of a stick type objective—After the marker is given to the observation site or its neighborhood and the endoscope is drawn out, preferably, the gas in the body cavity of the tested animal is removed, so that the previously formed space is contracted. Thereby, the epidermis and the observation site are made closer to one another, rendering it easy to check the position of the marker given on the observation site or on its perimeter or neighborhood from the outside of the tested animal. Then, by opening a hole passing into the body cavity from the epidermis adjacent the observation site specified with the position of the marker, the second small hole for inserting the thin diameter lens unit of the stick type objective is formed. Similarly to the case of the above-mentioned first embodiment, this second small hole can be formed e.g. by cutting with a scalpel or scissors a skin (epidermis) of about 1 cm in length on the targeted organ or site; exposing the muscular tunic; and piercing the peritoneum from the muscular tunic with a needle, etc. (FIG. 5). When the hole passing into the body cavity is formed in this way, the support base 14 of the objective is moved up and down such that the thin diameter lens unit 22 is inserted through the second hole. Further, in inserting the thin diameter lens unit 22 into the second small hole, preferably, about 50 μl of physiological salt solution is laid on the dissected region of the epidermis.

(i) Observation with an optical microscope—Then, an observation with an optical microscope is achieved by inserting the thin diameter lens unit 22 in the second small hole and adjusting the focus of the image of the thin diameter lens unit 22. As already noted, since the microscopic observation system 10 is a system which can be set up as a laser scanning type fluorescence microscope, the laser wavelength and the optical system, such as mirrors, are appropriately selected in accordance with the characteristics of the fluorescent labels of the observation site. Similarly to the case of the first embodiment, depending on the purposes of observations, the stick type objective may be exchanged to that having a different magnification or a numerical aperture. Since the observation site exists directly under the epidermis, the field of view of the newly attached objective can be relatively easily adjusted to the previously observed site without the checking of the position with the endoscope

Although the above explanations are made in relation to the embodiments of the present invention, it should be apparent for one of ordinary skill in the art that various corrections and changes are easily possible, and that the present invention may be applied to various constructions without being limited only to the embodiments illustrated above and deviating from the concept of the present invention.

For instance, although the observation method in which the second small hole is opened after the predetermination of an observation site with the endoscope was explained in the above-mentioned embodiments, it should be understood that an endoscope may be used for checking the position of the field of view of a stick type objective having been inserted in an animal. Further, although the case that a fluorescence observation is performed as an observation with an optical microscope was explained, a bright field observation may also be performed in an observation of an optical microscope, using illumination light or reflected light, etc. of an endoscope.

One of the important advantages of the inventive method is that the burden of a tested animal can be reduced, enabling a more prolonged observation than ever. In this respect, in a prolonged observation, the reduction of fluorescence intensity owing to metabolism and decomposition of dosed fluorescent dyes, etc. may occur. In such a case, the dosage of reagents, such as a fluorescent dye, may be appropriately executed during the observation. Further, the labeling of a fluorescent dye may be applied to an observation site through the fluid passage of an endoscope.

1. A method of microscopically observing a tissue or a cell in an inside of a body of a small animal in vivo with an objective having a thin diameter lens unit, characterized by comprising steps of:
opening in an epidermis site of the small animal a first small hole which can seal up the inside of the body of the small animal;
supplying gas to the inside of the body of the small animal through the first small hole to form a space in the inside of the epidermis site;
inserting an endoscope through the first small hole into the inside of the body of the small animal;
opening in the epidermis site of the small animal the second small hole which can seal up the inside of the body of the small animal;
inserting the thin diameter lens unit of the objective into the second small hole;
observing a position of a tip of the thin diameter lens unit inserted in the second small hole with the endoscope inserted through the first small hole, and positioning the tip of the thin diameter lens unit based on an image of the endoscope; and
observing a tissue or a cell in the inside of the body of the small animal with the objective having the thin diameter lens unit.

2. A method of claim 1, characterized in that, in the step of opening the second small hole, after determining the observation site of the inside of the body of the small animal with the endoscope, the second small hole is opened at a position rendering the observation site observable when the thin diameter lens unit is inserted in this second small hole; and in that, in the step of positioning the tip of the thin diameter lens unit, the tip of the thin diameter lens unit is positioned in the position rendering the observation site observable.

3. A method of claim 1, further comprising the steps of:
extracting the thin diameter lens unit from the second small hole, and inserting into the second small hole a second objective having a thin diameter lens unit with a magnification or numerical aperture being different from those of the extracted objective;
observing with the endoscope inserted in the first small hole a position of a tip of the thin diameter lens unit of the second objective inserted in the second small hole and the site which was observed with the extracted objective, and positioning the tip of the thin diameter lens unit of the second objective unit at a position such that the site which was observed with the extracted objective becomes observable based on an image of the endoscope; and
observing the observation site with the second objective having a thin diameter lens unit.

4. A method of microscopically observing a tissue or a cell in an inside of a body of a small animal in vivo with an objective having a thin diameter lens unit, characterized by comprising steps of:
opening in an epidermis site of the small animal a first small hole which can seal up the inside of the body of the small animal;
supplying gas to the inside of the body of the small animal through the first small hole to form a space in the inside of the epidermis site;
inserting an endoscope through the first small hole into the inside of the body of the small animal;
determining an observation site in the inside of the body of the small animal based on an image of the endoscope, and providing a marker to a portion in the inside of the body of the small animal so that a position of the determined observation site can be identified by eye observation from an outside of the small animal;
opening a second small hole in an epidermis site of the small animal adjacent the observation site defined with the marker;
inserting the thin diameter lens unit of the objective into the second small hole; and
observing the observation site with the objective.

5. A method of claim 4, characterized in that the marker is a colored, viscous liquid material; the endoscope has a marker sending out means which sends out the marker; and by the marker sending-out means, the marker is adhered to a portion in the inside of the body of the small animal which enables identifying the observation site.

6. A method of claim 1 or 4, characterized in that the endoscope has a means for sending out a gas; and the step of supplying gas to the inside of the body of the small animal through the first small hole to form a space in the inside of the epidermis site is performed after inserting the endoscope into the first small hole.

7. A method of claim 1 or 4, characterized in that a step of inserting a trokar in the first small hole prior to inserting the endoscope into the first small hole.
